(19) United States
(12) Patent Application Publication
(10) Pub. No.: US 2018/0023733 A1
(43) Pub. Date: Jan. 25, 2018

(54) PIPE ADAPTER

(71) Applicant: Hung-Lin Lai, Changhua (TW)

(72) Inventor: Hung-Lin Lai, Changhua (TW)

(73) Assignee: WEN SHENG FU CO., LTD, CHANGHUA (TW)

(21) Appl. No.: 15/214,326

(22) Filed: Jul. 19, 2016

(51) Int. Cl. F16L 21/00; F16L 21/03

(52) U.S. Cl. CPC F16L 21/007; F16L 21/03

(57) ABSTRACT

A pipe adapter may comprise a main body, an O-ring, a conical ring, an engaging ring, a control unit and a locating, tube, and a front opening formed at a front end of the main body which is configured to receive a pipe. Since the conical ring, engaging ring and locating tube are coupled in sequence instead of covering one by one such that there is no need to enlarge a diameter of the front opening of the main body for receiving the above components thereby lowering the manufacturing cost.

### FIELD OF THE INVENTION

The present invention relates to a pipe adapter, and more particularly to a pipe adapter that can be quickly connected or disconnected with a pipe.

### BACKGROUND OF THE INVENTION

Generally, referring to FIGS. 8 and 9, a conventional pipe adapter comprises a main body (80), an O-ring (81), a first tube (82), a locating ring (83), a locating piece (84), a guiding tube (85) and a pipe (86). A main body (80) has an opening (801) formed at a first end, and a first stepped edge (802) and a second stepped edge (803) are respectively formed at an inner periphery of the main body (80). Also, an inner diameter of the second stepped edge (803) is larger than the first stepped edge (802). The first stepped edge (802) is configured to receive the O-ring (81), and the first tube (82) engaged with the locating ring (83) and the locating piece (84) is received in the second stepped edge (803). An outer diameter of the O-ring (81) is the same as the inner diameter of the first stepped edge (802), and an inner diameter of the O-ring (81) is slightly small than an outer diameter of the pipe (86). Moreover, the O-ring (81) is configured to prevent water leak after the pipe (86) is inserted through the opening (801) and connected with the main body (80). An outer diameter of the first tube (82) is the same as the inner diameter of the second stepped edge (803), and an inner edge (821) formed at an inner periphery of the first tube (82) is configured to receive the locating ring (83). Furthermore, after the locating ring (83) is coupled with the inner periphery of the first tube (82), the locating piece (84) is engaged in the first tube (82) to limit the position of the locating ring (83). An outer edge (822) formed at an outer periphery of the first tube (82) is configured to couple with the second stepped edge (803) thereby securing the first tube (82) with the locating ring (83) and the locating piece (84) inside the main body (80). The locating ring (83) is made of metal material, and a plurality of elastic pieces (831) inclined protruding from a first surface of the locating ring (83) which faces to an inner space of the main body (80). When the elastic pieces (831) are pressed toward the inner space of the main body (80), the inner diameter of the locating ring (83) is smaller than the outer diameter of the pipe (86) such that the elastic pieces (831) are caught an outer periphery of the tube (86). On the other hand, when the elastic pieces (831) pressed and expanded toward the opening (801) of the main body (80), the inner diameter of the locating ring (83) is larger than the outer diameter of the pipe (86) thereby allowing the pipe (86) to disconnect with main body (80). The locating piece (84) is configured to secure the locating ring (83) inside the first tube (82), and a tapered surface (841) formed at an inner periphery of the locating piece (84) is configured to reserve space for the elastic pieces (831) of the locating ring (83) when the elastic pieces (831) expanded outwardly The guiding tube (85) further has an engaging portion (851) which is formed at a rear end thereof and is configured to be forced and received in the inner edge (821) of the first tube (82). A front end of the guiding tube (85) far from he inner space of the first tube (80) comprises a pressing portion (852) which is configured to allow a user to press the guiding tube (85) inwardly.

However, the conventional pipe adapter has following disadvantages: the locating ring (83) and the locating piece (84) need to be secured inside the first tube (82) before putting in the main body (80) through, the opening (801). As a result, the opening (801) of the main body (80) needs to be enlarged to allow the components to pass through, so the cost of material is increased. Therefore, there remains a need for a new and improved design for a pipe adapter to overcome the problems presented above.

### SUMMARY OF THE INVENTION

The present invention provides a pipe adapter which comprises a main body, an O-ring, a conical ring, an engaging ring, a control unit and a locating tube, and a front opening formed at a front end of the main body which is configured to receive a pipe. A first flange and a second flange which are formed in the stepped shape and located inside the front opening are configured to respectively receive the O-ring and the conical ring. The conical ring comprises a rear edge and a front edge which are respectively far from and close to the front opening. The conical ring is secured inside the main body after the O-ring is coupled inside the main body such that the rear edge is coupled on the second flange of the main body thereby limiting the position of the conical ring. Moreover, a tapered surface is formed around an inner periphery of the conical ring. The engaging ring has an annular base which is configured to bear against the front edge of the conical ring. A plurality of second protruding teeth protrude from a rear edge of the annular base toward the conical ring. The control unit has a connecting tube, and a protruding edge which comprises a tapered guiding surface protrudes from an outer periphery of a rear end of the connecting tube. The locating tube comprises a first opening and a second opening which are communicated with each other, and an inner space adjacent to the first opening has a blocking edge. As a result, the connecting tube of the control unit is configured to penetrate through the first opening and since the protruding edge is borne against the blocking edge such that the control unit is secured inside the locating tube without falling out from the second opening. The first opening of the locating tube faces to the front opening of the main body, and the annular base of the engaging ring is secured between the front edge of the conical ring and the first opening of the locating tube. Also, a restricted edge formed around the front opening of the main body is configured to press an outer periphery of the second opening of the locating tube thereby securing the locating tube and other components inside the main body

Comparing with conventional pipe adapter, the present invention is advantageous because: since the conical ring, engaging ring and locating tube are coupled in sequence instead of covering, one by one such that there is no need to enlarge a diameter of the front opening of the main body for receiving the above components thereby lowering the manufacturing cost.

### BRIEF DESCRIPTION OF THE DRAWINGS

FIG. 1 is a three-dimensional assembly view of a pipe adapter in the present invention.

FIG. 2 is a three-dimensional exploded view of the pipe adapter in the present invention.

FIG. 3 is a sectional assembly view of the pipe adapter in the present invention,

FIG. 4 is a sectional assembly view illustrating the pipe adapter of the present invention is connected to a pipe (A).

FIG. 5 is a sectional view illustrating the pipe (A) is disconnected from the pipe adapter of the present invention.

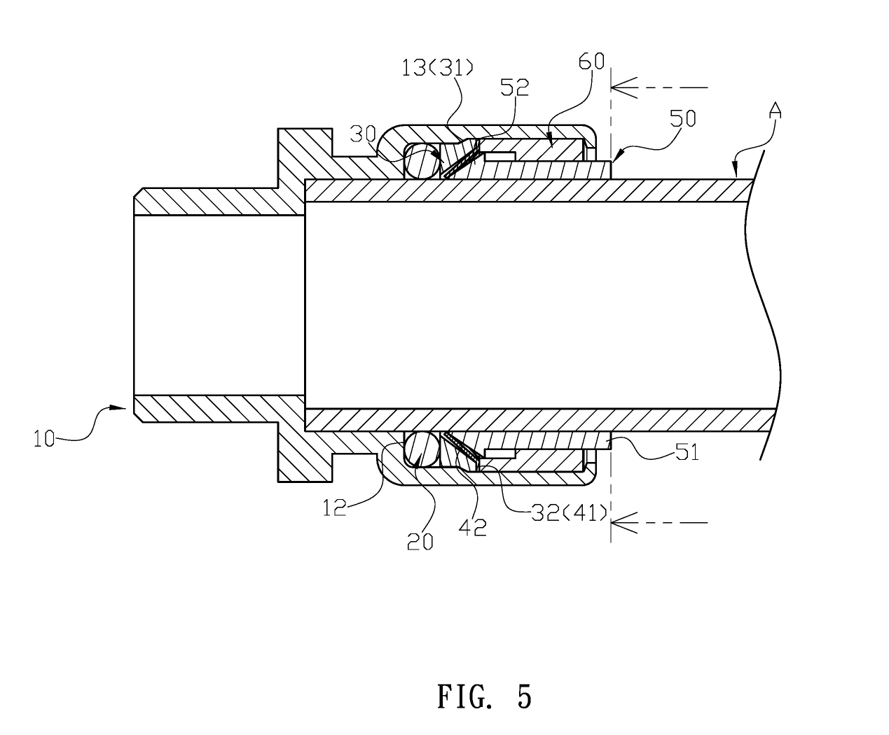

FIG. 6 is a sectional assembly view of another embodiment of the pipe adapter in the present invention.

FIG. 7 is a three-dimensional exploded view of still another embodiment of the pipe adapter in the present invention.

FIG. 8 is a prior art.

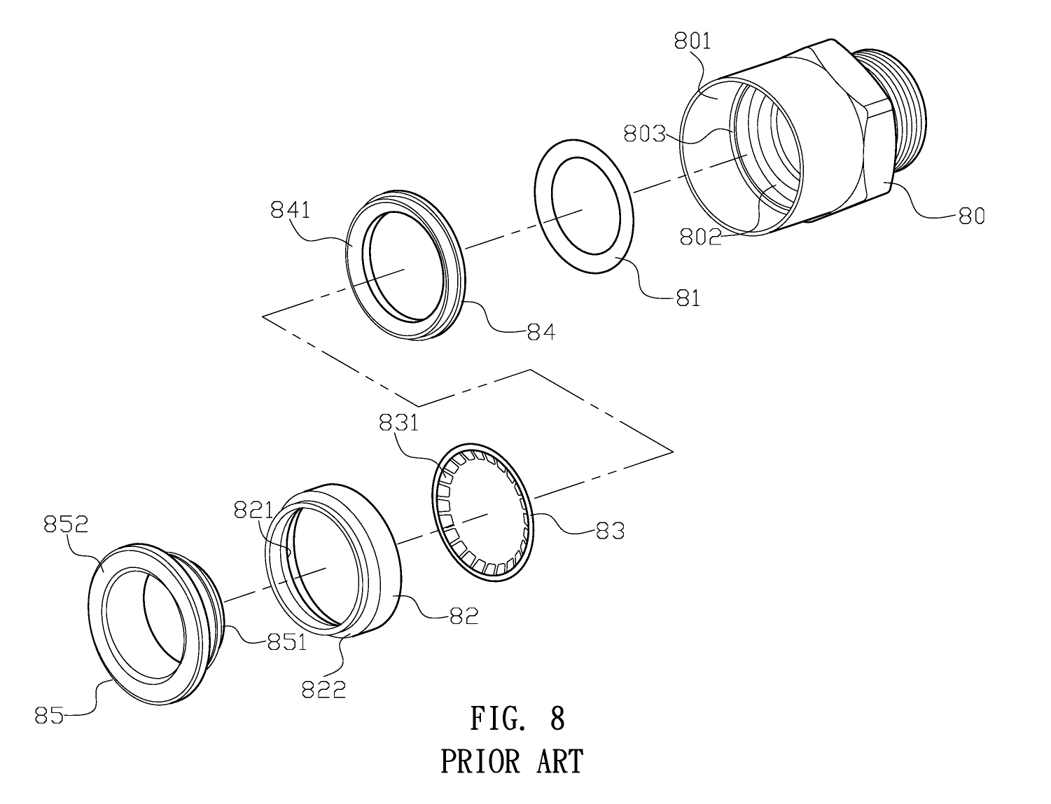

FIG. 9 is a prior art.

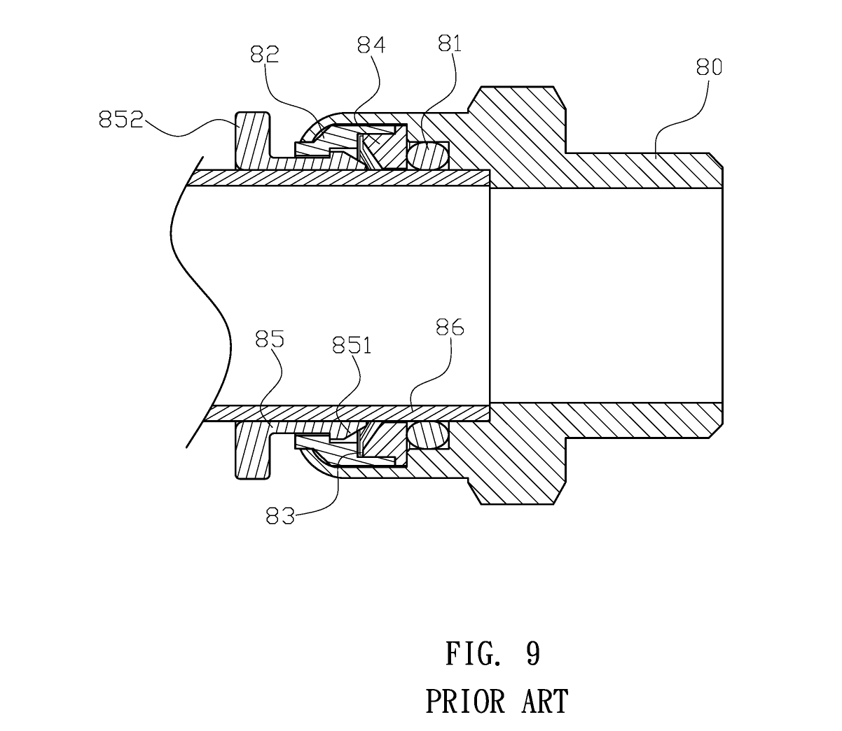

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same mean as commonly understood to one of ordinary skill in the art to which this invention belongs. Although any methods, devices and materials similar or equivalent to those described can be used in the practice or testing of the invention, the exemplary methods, devices and materials are now described.

All publications mentioned are, incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

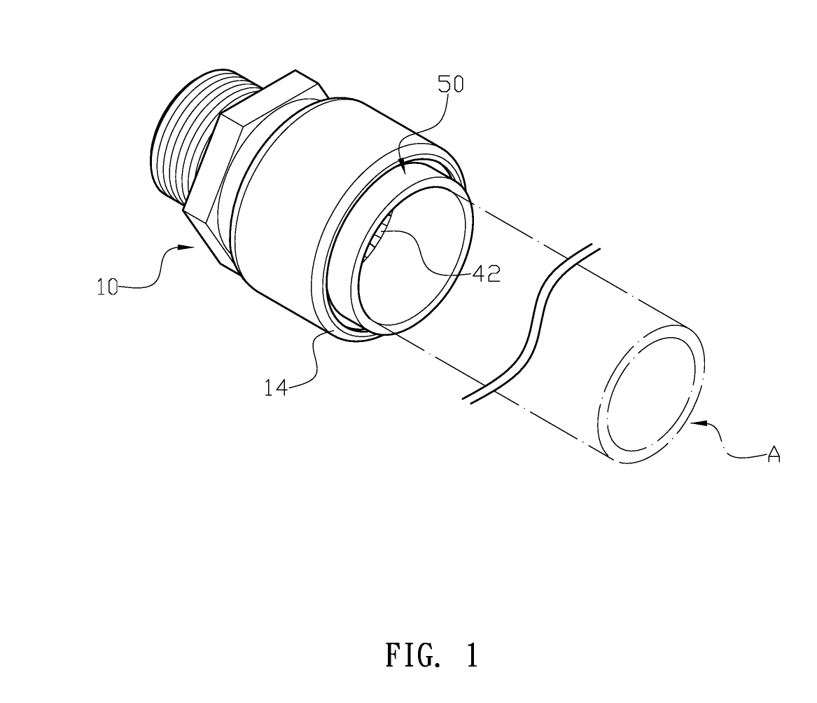

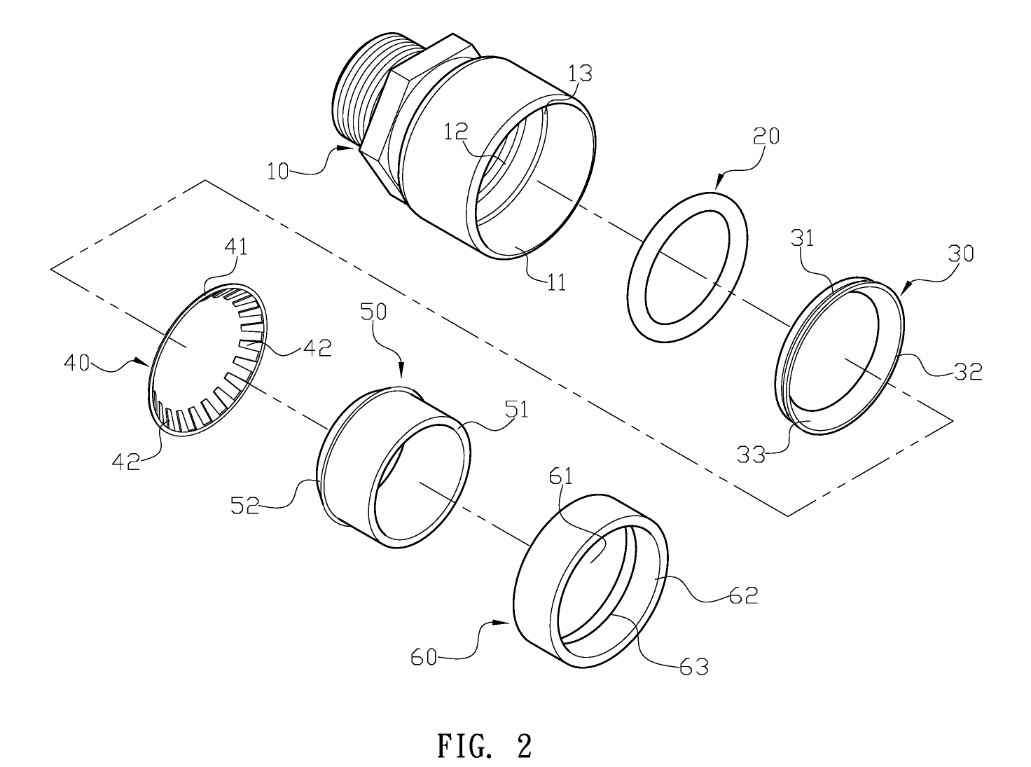

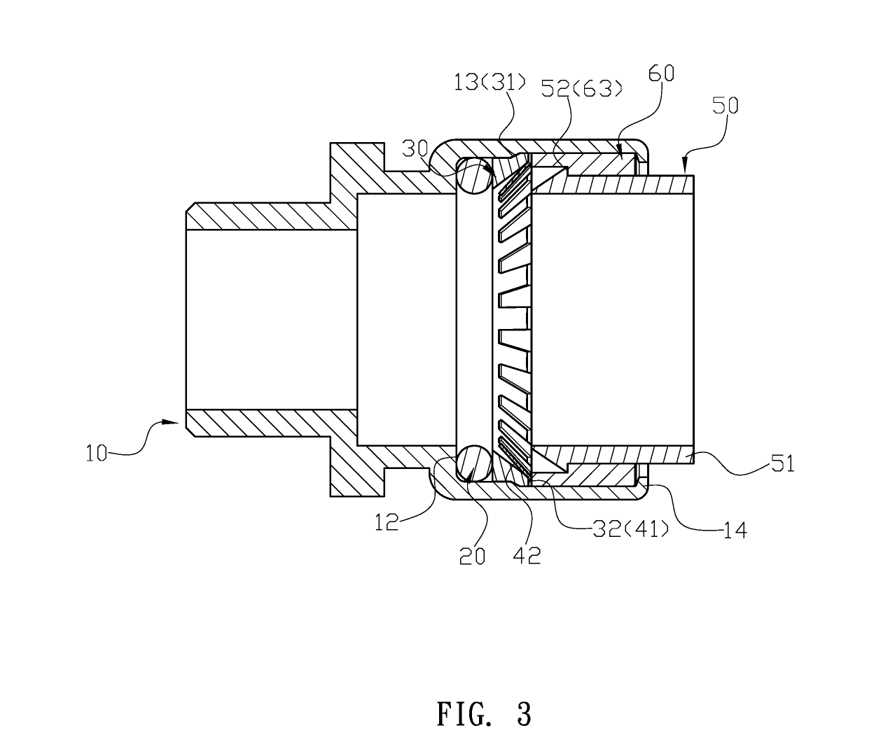

Referring to FIGS. 1 to 3, the present invention provides a pipe adapter which comprises a main body (10), an O-ring (20), a conical ring (30), an engaging ring (40), a control unit (50) and a locating tube (60), and a front opening (11) formed at a front end of the main body (10) which is configured to receive a pipe (A). A first flange (12) and a second flange (13) which are formed in the stepped shape and located inside the front, opening (11) are configured to respectively receive the O-ring (20) and the conical ring (30). The conical ring comprises a rear edge (31) and a front edge (32) which are respectively far from and close to the front opening (11). The conical ring (30) is secured inside the main body (10) after the O-ring (20) is coupled inside the main body (10) such that the rear edge (31) is coupled on the second flange (12) of the main body (10) thereby limiting the position of the conical ring (30). Moreover, a tapered surface (30) is formed around an inner periphery of the conical ring (30). The engaging ring (40) has an annular base (41) which is configured to bear against the front edge (32) of the conical ring (30). A plurality of second protruding teeth (42) protrude from a rear edge of the annular base (41) toward the conical ring (30). The control unit (50) has a connecting tube (51), and a protruding edge (52) which comprises a tapered guiding surface protrudes from an outer periphery of a rear end of the connecting tube (51). The locating tube (60) comprises a first opening (61) and a second opening (62) which are communicated with each other, and an inner space adjacent to the first opening (61) has a blocking edge (63). As a result, the connecting tube (51) of the control unit (50) is configured to penetrate through the first opening (61) and since the protruding edge (52) is borne against the blocking edge (63) such that the control unit (50) is secured inside the locating tube (60) without falling out from the second opening (62). The first opening (61) of the locating tube (60) faces to the front opening (11) of the main body (10), and the annular base (41) of the engaging ring (40) is secured between the front edge (32) of the conical ring (30) and the first opening (61) of the locating tube (60). Also, a restricted edge (14) formed around the front opening (11) of the main body (10) is configured to press an outer periphery of the second opening (62) of the locating tube (60) thereby securing the locating tube (60) and other components inside the main body (10).

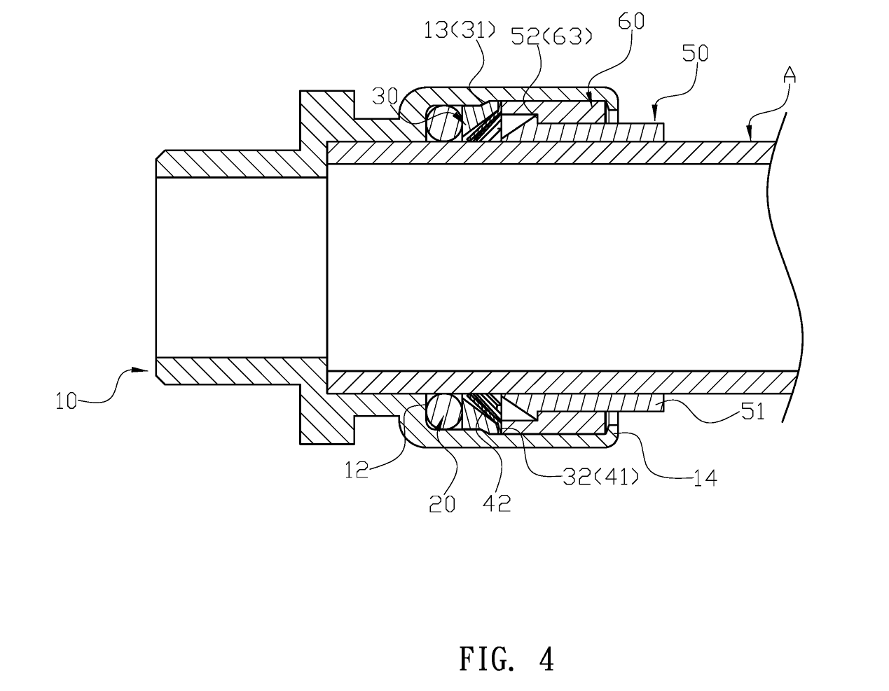

Referring to FIG. 4, in actual application, the pipe (A) is inserted and connected to the main body (10) through the connecting tube (51) of the control unit (50), and a position of the pipe (A) is secured when the second protruding teeth (42) of the engaging ring (40) catch an outer wall of the pipe (A). Furthermore, since a front portion of the connecting tube (51) protrudes from the second opening (62) of the locating tube (60), a user can press the connecting tube (51) near the second opening (62) and move the protruding edge (52) to push the second protruding teeth (42) thus allowing the pipe (A) to quick disconnect from the main body (10) (as shown in FIG, 5).

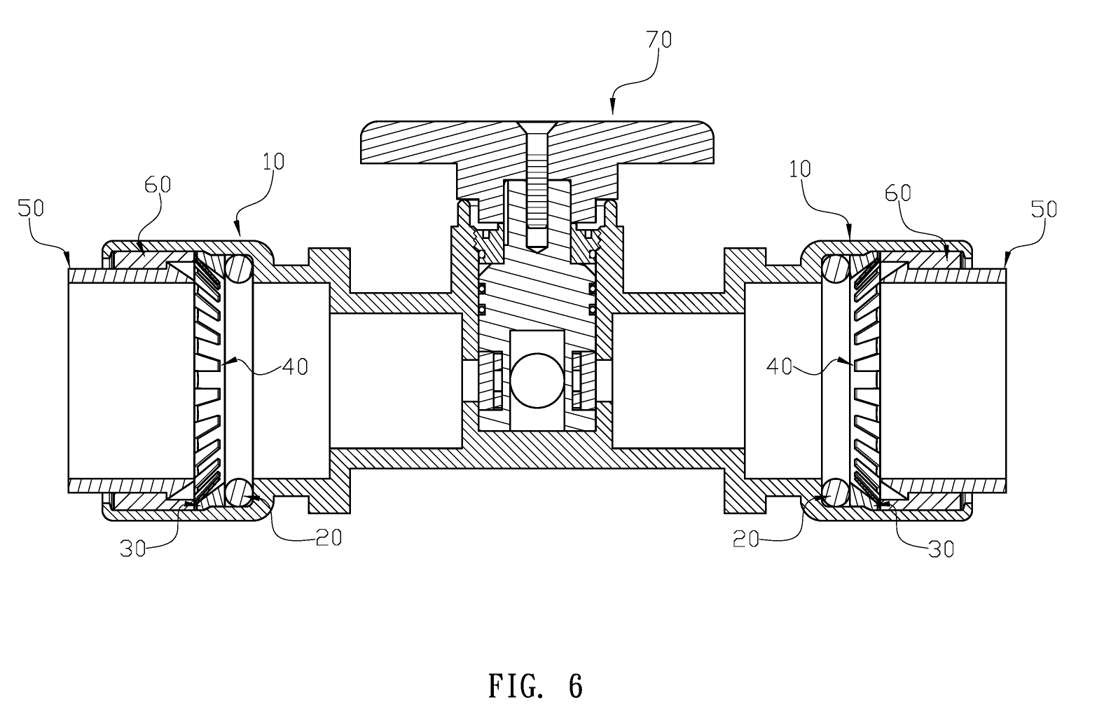

In addition, referring to FIG. 6, in another embodiment, two pipe adapters of the present invention can be cooperated with a water control unit (70). Each of the two pipe adapters has one main body (10), and the two main bodies (10) are connected face to face and cooperate with the water control unit (70) thereby providing water or other liquids through the pipe adapters to each of two pipes.

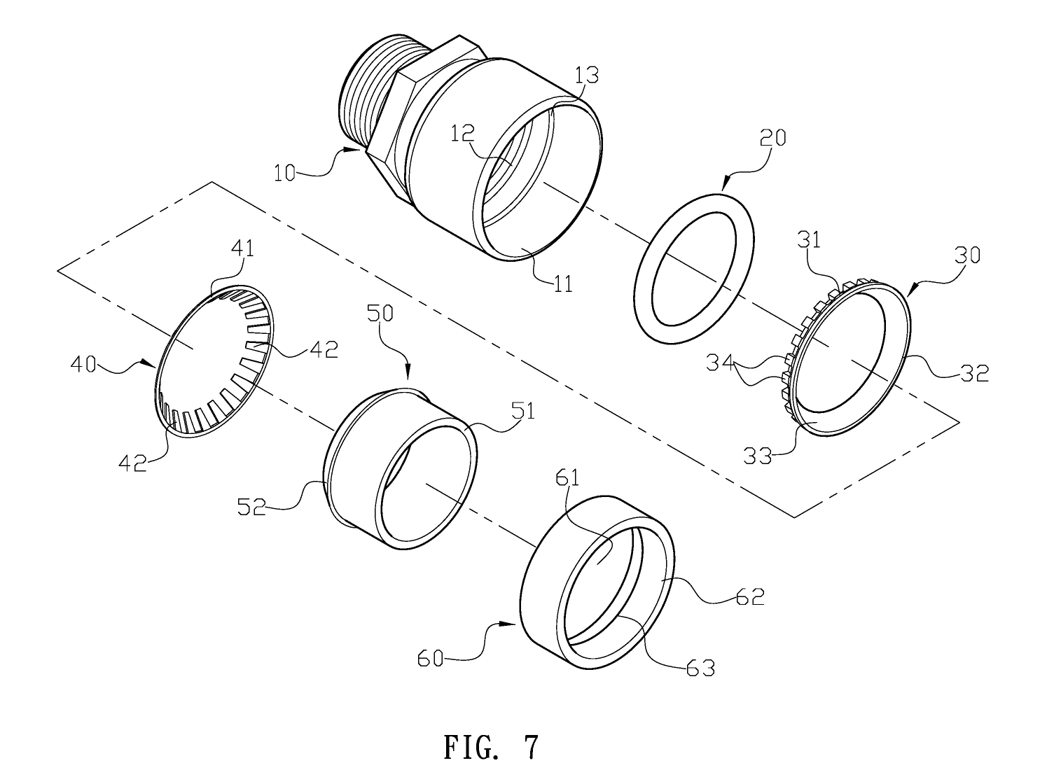

In still another embodiment, an outer periphery of the conical ring (30) comprises a plurality of first protruding teeth (34) (as shown in FIG. 7).

Comparing with conventional pipe adapter, the present invention is advantageous because: since the conical ring (30), engaging ring (40) and locating tube (60) are coupled in sequence instead of covering one by one such that there is no need to enlarge a diameter of the front opening (11) of the main body (10) for receiving the above components thereby lowering the manufacturing cost.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A pipe adapter comprising:
a main body having a front opening formed at a front end thereof, and a first flange and a second flange, which are formed in stepped shapes and located inside the front opening, configured to respectively receive an O-ring and a conical ring;
the conical ring, which comprises a rear edge and a front edge, secured inside the main body after the O-ring settled and coupled in the main body such that the rear edge configured to, couple on the second flange of the main body thereby limiting the position of the conical ring, and a tapered surface formed around an inner periphery of the conical ring;
an engaging ring having an annular base which is configured to hear against the front edge of the conical ring, and a plurality of second protruding teeth protruding from a rear edge of the annular base toward the conical ring;
a control unit comprising a connecting tube, and a protruding edge, which has a tapered guiding surface, protruding from an outer periphery of a rear end of the connecting tube; and
a locating tube having a first opening and a second opening which are communicated with each other, and an inner surface adjacent to the first opening having a blocking edge such that, after the connecting tube penetrating through the first opening, the protruding edge configured to bear against the blocking edge thereby limiting a position of the control unit in the locating tube without falling out from the second opening, the first opening of the locating tube facing to the front opening of the main body when the locating tube with other components received in the main body, and the annular base of the engaging ring secured between the front edge of the conical ring and the first opening of the locating tube, and a restricted edge, which is formed around an outer periphery of the front opening of the main body, configured to press on an outer periphery of the second opening thus securing a position of the locating tube.

2. The pipe adapter of claim 1, wherein an outer periphery of the conical ring comprises a plurality of first protruding teeth.

3. The pipe adapter of claim 1, wherein the main body is connected to a single pipe.

4. The pipe adapter of claim 1, wherein two pipe adapters are configured to cooperate each other while the two main bodies are connected, and two pipe adapters are configured to cooperate with a water control unit as an on/off operating valve set.
